(19) United States
(12) Patent Application Publication
(10) Pub. No.: US 2010/0103051 A1
(43) Pub. Date: Apr. 29, 2010

(54) ANTENNA MODULE AND PORTABLE ELECTRONIC DEVICE USING THE SAME

(75) Inventor: ZHAN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignee: FIH (Hong Kong) Limited, Kowloon (HK)

(21) Appl. No.: 12/556,249

(22) Filed: Sep. 9, 2009

(30) Foreign Application Priority Data
Oct. 27, 2008 (CN) 200810171758.6

(51) Int. Cl. H01Q 1/36

(52) U.S. Cl. 343/700 MS

(57) ABSTRACT

An antenna module includes a carrying layer, a substrate, an antenna layer disposed between the carrying layer and the substrate, and a resonate coupler attached to the substrate and resonant coupling with the antenna layer. The resonate coupler and the antenna layer are separated by the substrate.

### BACKGROUND

1. Technical Field

The present disclosure relates to antenna modules, and particularly to an antenna module used in portable electronic devices.

2. Description of Related Art

Portable electronic devices, such as mobile phones, personal digital assistants (PDAs) and laptop computers are widely used. Most of these portable electronic devices have antenna modules for receiving/sending wireless signals.

Referring to FIG. 2, a related portable electronic device is provided. The portable electronic device includes an outer layer 91, an antenna layer 92, an inner layer 93, a conductive terminal 94, a printed circuit board (not shown), and a conductive post 95 connecting to the printed circuit board. The outer layer 91 is a plastic film for supporting the antenna layer 92. The antenna layer 92 is attached to and located between the outer layer 91 and the inner layer 93. The conductive terminal 94 electrically contacts the antenna layer 92 and exposes to connect the conductive post 95. The portable electronic device is usually manufactured by the following steps. The antenna layer 92 is attached to the outer layer 91. The conductive terminal 94 is welded on the antenna layer 92. The outer layer 91 and the antenna layer 92 are placed into a mold for injection molding the inner layer 93 on the antenna layer 92.

However, the manufacturing process costs time and money, and can also be difficult to achieve.

Therefore, there is a room for improvement within the art.

### BRIEF DESCRIPTION OF THE DRAWINGS

Many aspects of an antenna module and portable electronic device using the same can be better understood with reference to the following drawings. The components in the drawings are not necessarily to scale, the emphasis instead being placed upon clearly illustrating the principles of the antenna module and portable electronic device using the same. Moreover, in the drawings, like reference numerals designate corresponding parts throughout the several views.

FIG. 1 is a cross-sectional view of a portable electronic device having an antenna module, according to an exemplary embodiment.

FIG. 2 is a cross-sectional view of a typical portable electronic device having an antenna module.

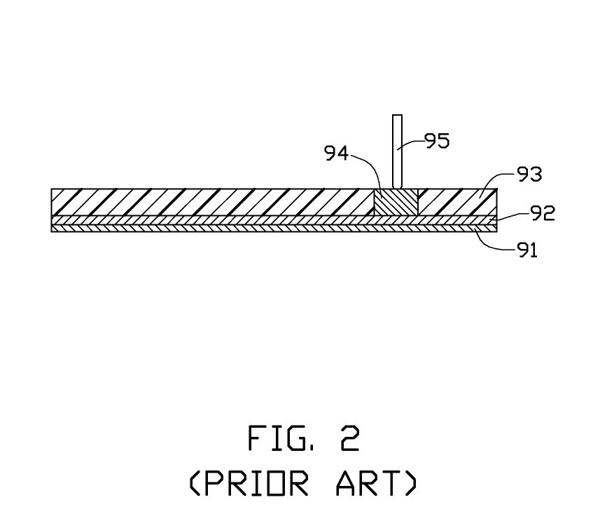

### DETAILED DESCRIPTION OF THE EMBODIMENTS

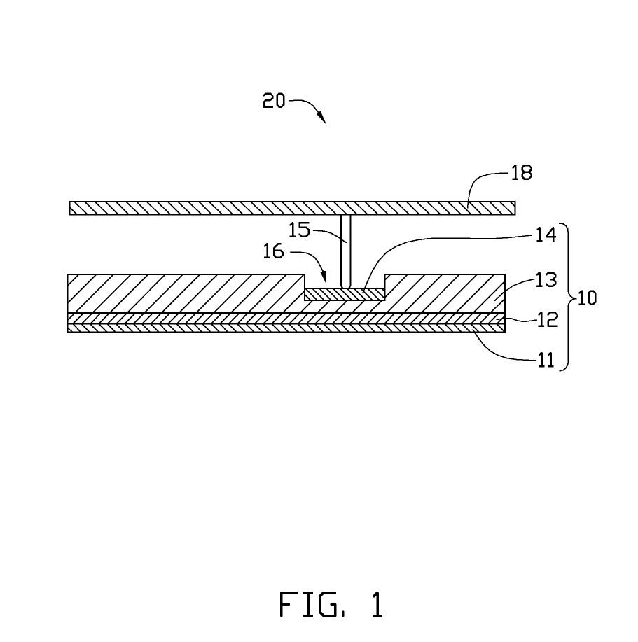

FIG. 1 shows an antenna module 10 including a carrying layer 11, an antenna layer 12, a substrate 13, and a resonate coupler 14.

The carrying layer 11 may be made of a resin material selected from a group consisting of polycarbonate (PC), acrylonitrile-butadiene-styrene (ABS), polystyrene (PS), and polyvinylchloride (PVC), etc. The carrying layer 11 is configured for carrying the antenna layer 12.

The antenna layer 12 is used to receive and transmit wireless signal. The antenna layer 12 can be made of a conductive ink film and directly coated on the carrying layer 11. Alternatively, the antenna layer 12 can be made of a metallic foil attached/adhered to the carrying layer 11. Alternatively, the antenna layer 12 can be a metallic coating evaporated or electroplated to the carrier layer 11.

The substrate 13 is an insulative layer injection molded on the antenna layer 12. Accordingly, the antenna layer 12 is located between the substrate 13 and the carrying layer 11. The substrate 13 is made of a plastic material selected from a group consisting of polycarbonate, acrylonitrile-butadiene-styrene, polythene (PE), polymethyl methacrylate (PMMA), polyethylene terephthalate (PET), polyvinyl chloride (PVC) resin, and silica gel, etc. The substrate 13 is configured for protecting the antenna layer 12 and separating the antenna layer 12 from the resonate coupler 14.

The resonate coupler 14 is an electrical conductive sheet made of metal, conductive ceramics, stannic oxide, or silver oxide. The resonate coupler 14 can alternatively be a metallic coating deposited on the substrate 13. The exemplary conductive sheet is a copper foil and couples with the antenna layer 12 in a resonant manner. Surface areas of the resonate coupler 14 is ranged from about 1 square millimeter to about 36 square millimeters. The resonate coupler 14 is attached to the substrate 13 opposite to the antenna layer 12. In this case, the resonate coupler 14 and the antenna layer 12 are separated by the substrate 13 with a distance less than about 1 millimeter. The resonate coupler 14 is configured for resonant coupling with the antenna layer 12.

The substrate 13 has an exposed receiving slot 16. The resonate coupler 14 can be partially received and secured in the receiving slot 16. As such, the resonate coupler 14 and the antenna layer 12 may maintain a suitable/acceptable distance by adjusting the depth of the receiving slot 16.

An exemplary portable electronic device 20 includes the antenna module 10 as described above and a printed circuit board 18. The printed circuit board 18 includes a conductive element 15. By an electrical connection of the conductive element 15 to the resonate coupler 14, the antenna layer 12 coupled with the resonate coupler 14 can inter-transmit wireless signal with the printed circuit board 18 through the conductive element 15.

According to the description as set forth, the antenna layer 12 does not need to connect to conductive terminals. Therefore, the process of welding conductive terminals to the antenna layer 12 can be omitted, which can greatly decrease the manufacturing cost for the antenna module 10.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna module, comprising:
a carrying layer;
a substrate;
an antenna layer disposed between the carrying layer and the substrate; and
a resonate coupler attached to the substrate and for resonant coupling with the antenna layer;
wherein the resonate coupler and the antenna layer are separated by the substrate.

2. The antenna module as claimed in claim 1, wherein the carrying layer is made of resin.

3. The antenna module as claimed in claim 1, wherein the antenna layer is selected from a group consisting of conductive ink, metallic foil, and metal coating.

4. The antenna module as claimed in claim 1, wherein the substrate have a receiving slot defined in an opposite side of substrate to antenna layer, the resonate coupler is received in the receiving slot.

5. The antenna module as claimed in claim 1, wherein the resonate coupler and the antenna layer are separated by the substrate with a distance less than about 1 millimeter.

6. The antenna module as claimed in claim 1, wherein the resonate coupler is selected from a group consisting of metal, conductive ceramics, stannic oxide, silver oxide, and metal coating.

7. The antenna module as claimed in claim 6, wherein the metal is copper.

8. The antenna module as claimed in claim 6, wherein surface areas of the resonate coupler is ranged within about 1 square millimeter and about 36 square millimeters.

9. A portable electronic device, comprising:
a printed circuit board including a conductive element connecting thereto; and
an antenna module including:
a carrying layer;
a substrate;
an antenna layer disposed between the carrying layer and the substrate; and
a resonate coupler attached to the substrate and for resonant coupling with the antenna layer;
wherein the resonate coupler and the antenna layer are separated by the substrate, the conductive element electrically connects to the resonate coupler.

10. The portable electronic device as claimed in claim 9, wherein the carrying layer is made of resin.

11. The portable electronic device as claimed in claim 9, wherein the antenna layer is selected from a group consisting of conductive ink, metallic foil, and metal coating.

12. The portable electronic device as claimed in claim 9, wherein the substrate have a receiving slot defined in an opposite side of substrate to antenna layer, the resonate coupler is received in the receiving slot.

13. The portable electronic device as claimed in claim 9, wherein the resonate coupler and the antenna layer are separated by the substrate with a distance less than about 1 millimeter.

14. The portable electronic device as claimed in claim 10, wherein the resonate coupler is selected from a group consisting of metal, conductive ceramics, stannic oxide, silver oxide, and metal coating.

15. The portable electronic device as claimed in claim 14, wherein the metal is copper.

16. The portable electronic device as claimed in claim 14, wherein surface areas of the resonate coupler is ranged within about 1 square millimeter and about 36 square millimeters.
